(19) United States
(12) Patent Application Publication
(10) Pub. No.: US 2009/0115574 A1
(43) Pub. Date: May 7, 2009

(54) RADIO FREQUENCY IDENTIFICAITON TAG

(75) Inventors: Yung-Ping TIEN, TAIPEI COUNTY (TW); Hui-Chuan CHEN, HSINCHU CITY (TW); Pi-Chuan HUNG, TAICHUNG CITY (TW); Hsiao-Han CHANG, HSINCHU COUNTY (TW); Wei-Hsuan SHIEH, TAIPEI CITY (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/967,945

(22) Filed: Dec. 31, 2007

(30) Foreign Application Priority Data
Nov. 5, 2007 (TW) TW96141691

(51) Int. Cl. H04Q 5/22

(52) U.S. Cl. 340/10.1

(57) ABSTRACT

A radio frequency identification tag is provided, comprising: memory, storing at least one item of specific identification data; a logic circuit, connected to the memory, comprising at least a port to receive a trigger signal from an external source, and retrieving one item of the specific identification data from the memory according to the trigger signal; and an antenna, connected to the logic circuit, transmitting the specific identification data retrieved by the logic circuit.

### BACKGROUND

The invention relates to a radio frequency identification tag (RFID tag), and in particular to a radio frequency identification tag capable of alternatively transmitting specific identification data stored in a memory thereof.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

FIG. 1 illustrates a schematic view of a block diagram of a conventional radio frequency identification tag (RFID tag). RFID tag 10 comprises an antenna 11, a logic circuit 13, and a memory 15.

The antenna 11 establishes a connection with a reader (not shown), and transmits/receives data between the reader and logic circuit 13. The memory 15 stores an item of identification data.

Conventionally, an RFID tag 10 comprises only one item of identification data. When reading the RFID tag 10, the identification data stored in memory 15 is retrieved.

While the RFID tag 10 can be changed to present different information, a reader or other devices is required for writing new information into the memory 15. Accordingly, additional time and devices are required, thus increasing costs.

### SUMMARY

Certain exemplary aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A radio frequency identification tag is provided. The radio frequency identification tag comprises a memory, a logic circuit, and an antenna. The memory stores at least one item of specific identification data. The logic circuit, coupled to the memory, comprises at least one port for receiving a trigger signal from an external source, and selects and retrieves one item of the specific identification data from the memory according to the trigger signal. The antenna, connected to the logic circuit, transmits the specific identification data retrieved by the logic circuit.

Another radio frequency identification tag is provided. The radio frequency identification tag comprises a memory, a switching circuit, a logic circuit, and an antenna. The memory stores at least one item of specific identification data. The switching circuit comprises at least one port for receiving a trigger signal from an external source, and selects one item of the specific identification data stored in the memory according to the trigger signal. The logic circuit, coupled to the memory and the switching circuit respectively, retrieves the selected item of the specific identification data from the memory. The antenna, connected to the logic circuit, transmits the specific identification data retrieved by the logic circuit.

Yet another radio frequency identification tag is provided. The radio frequency identification tag comprises a memory, a switching circuit, a logic circuit, and an antenna. The memory stores at least one item of specific identification data. The switching circuit, coupled to the memory, comprises at least one port for receiving a trigger signal from an external source, and selects and retrieves one item of the specific identification data stored in the memory according to the trigger signal. The logic circuit, coupled to the switching circuit, receives the retrieved item of the specific identification data from the switching circuit. The antenna, connected to the logic circuit, receives the specific identification data from the logic circuit, and transmits the received specific identification data.

Also, another radio frequency identification tag is provided. The radio frequency identification tag comprises a memory, a second antenna, a second logic circuit, a first logic circuit, and a first antenna. The memory stores at least one item of specific identification data. The second antenna receives a trigger signal from an external source. The second logic circuit receives the trigger signal from the second antenna, and transmits the received trigger signal to a first logic circuit. The first logic circuit, coupled to the second logic circuit, receives the trigger signal from the second logic circuit, selects and retrieves one item of the specific identification data stored in the memory according to the trigger signal. The first antenna, coupled to the first logic circuit, operates in a frequency different from the second antenna, receives the specific identification data from the first logic circuit, and transmits the received specific identification data.

Also, yet another radio frequency identification tag is provided. The radio frequency identification tag comprises a memory, a first antenna, a second antenna, and a logic circuit. The memory stores at least one item of specific identification data. The first antenna transmits one of the specific identification data. The second antenna, operates in a frequency different from the first antenna, receives a trigger signal from an external source. The logic circuit, coupled to the first antenna, second antenna, and the memory respectively, selects and retrieves one item of the specific identification data stored in the memory according to the trigger signal, and relays the specific identification data to the first antenna for transmission.

### BRIEF DESCRIPTION OF DRAWINGS

The invention can be more fully understood by reading the subsequent detailed description and examples with references made to the accompanying drawings, wherein:

FIG. 1 illustrates a schematic view of a block diagram of a conventional radio frequency identification tag;

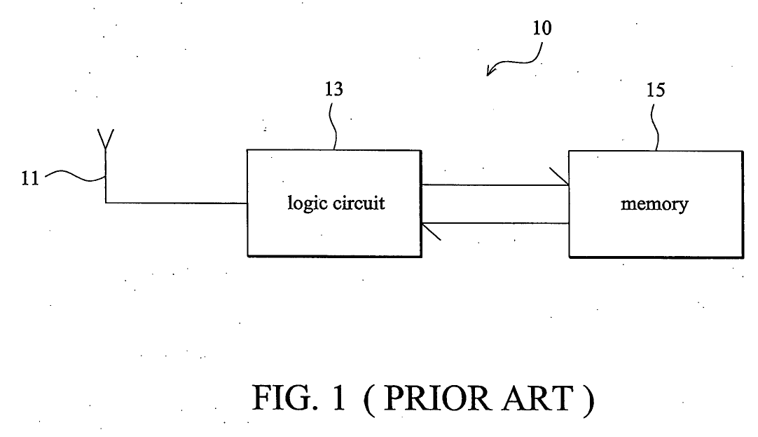

FIG. 2 illustrates a schematic view of a block diagram of a first embodiment of a radio frequency identification tag;

FIG. 3 illustrates a schematic view of a block diagram of a second embodiment of a radio frequency identification tag;

FIG. 4 illustrates a schematic view of a block diagram of a third embodiment of a radio frequency identification tag;

FIG. 5 illustrates a schematic view of a block diagram of a fourth embodiment of a radio frequency identification tag; and

FIG. 6 illustrates a schematic view of a block diagram of a fifth embodiment of a radio frequency identification tag.

### DETAILED DESCRIPTION

One or more exemplary embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve specific developer goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. The leading digit(s) of reference numbers appearing in the figures corresponds to the figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

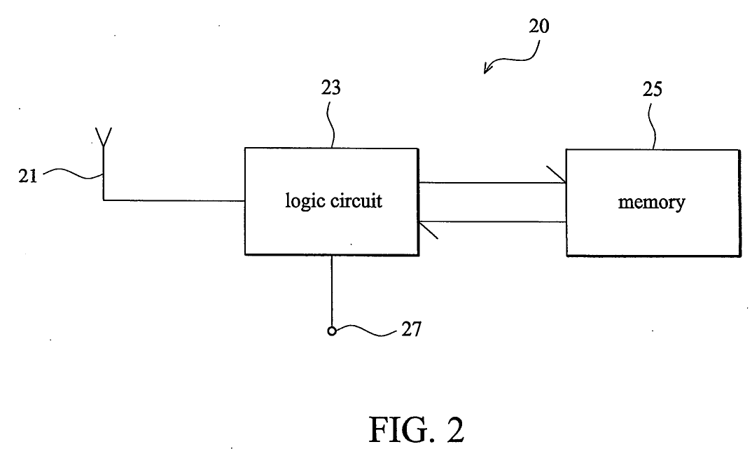

FIG. 2 illustrates a schematic view of a block diagram of a first embodiment of a radio frequency identification tag. RFID tag 20 comprises an antenna 21, a logic circuit 23, and a memory 25.

The memory 25 stores at least one item of specific identification data, comprising a signal memory unit, a plurality of memory units, or combinations thereof.

The antenna 21 establishes a wireless communication connection with a reader (not shown), and transmits/receives data between the reader and logic circuit 23. The antenna 21 transmits one item of the specific identification data stored in memory 25 according to direction of logic circuit 23.

The logic circuit 23 is connected with antenna 21, and is coupled to memory 25. The logic circuit 23 comprises a port 27 for receiving a trigger signal from an external source, and selects one item of the specific identification data from the memory 25 according to the trigger signal. The antenna 21 transmits the specific identification data selected by the logic circuit 23 to a reader.

According to the first embodiment, when logic circuit 23 receives a trigger signal, the antenna 21 transmits the selected specific identification data to a reader according to direction of logic circuit 23. Accordingly, RFID tag 20 alternatively retrieves and transmits different specific identification data to the reader in a dynamic way according to the trigger signal.

The way in which the logic circuit 23 alternatively retrieving the specific identification data stored in memory 25 can be designed to meet requirements.

For example, the logic circuit 23 can alternatively select one item of the specific identification data stored in the memory 25 in a sequential order. If the logic circuit 23 has not received the trigger signal, the logic circuit 23 can select the first item of specific identification data stored in the memory 25, thus the first item of specific identification data stored in the memory 25 would be transmitted to the reader by the antenna 21. If the logic circuit 23 receives the trigger signal for the first time, logic circuit 23 can select the second item of specific identification data stored in the memory 25, thus the second item of specific identification data stored in the memory 25 would be transmitted to the reader by the antenna 21.

In the prior examples, once the last item of the specific identification data stored in the memory has been selected, the last item of the specific identification data will remain to be the selected item (which is transmitted to the reader); no matter how many times the trigger signal is later received.

For another example, the logic circuit 23 can alternatively select one item of the specific identification data stored in the memory in a sequential order recurrently. In this example, when a trigger signal is received after the last item of the specific identification data stored in the memory is selected, the first item of the specific identification data is the selected item (which is transmitted to the reader).

For yet another example, if the trigger signal comprises data designation information for designating one item of the specific identification data stored in the memory 25, logic circuit 23 can select one item of the specific identification data stored in the memory 25 according to the data designation information. The selected item of the specific identification data is then transmitted to the reader.

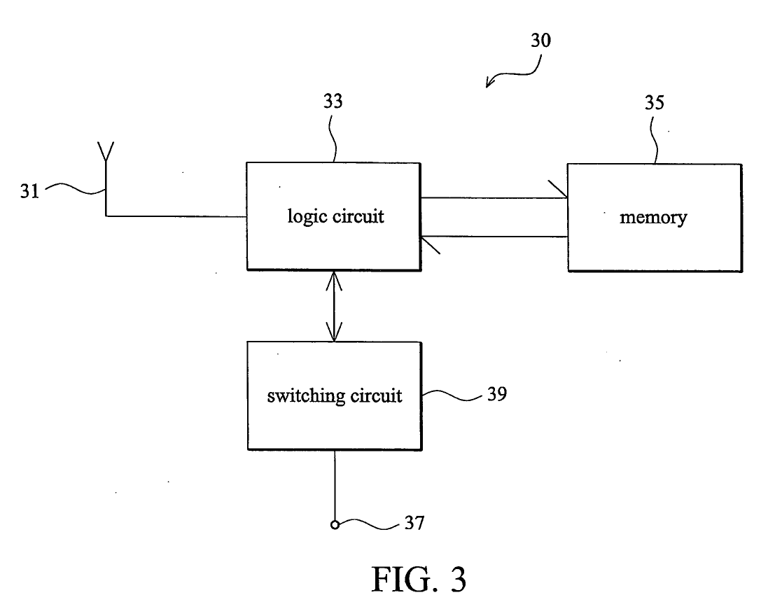

FIG. 3 illustrates a schematic view of a block diagram of a second embodiment of a radio frequency identification tag. RFID tag 30 comprises an antenna 31, a logic circuit 33, switching circuit 39, and a memory 35.

The memory 35 stores at least one item of specific identification data, comprising a signal memory unit, a plurality of memory units, or combinations thereof.

The antenna 31 establishes a wireless communication connection with a reader (not shown), and transmits/receives data between the reader and logic circuit 33. The antenna 31 transmits one item of the specific identification data stored in memory 35 according to direction of logic circuit 33.

The logic circuit 33 is connected with antenna 31, and is coupled to memory 35 and switching circuit 39. The switching circuit 39 comprises a port 37 for receiving a trigger signal from an external source, selects one item of the specific identification data from the memory 35 according to the trigger signal, and transmits the selected item to the antenna 31 through logic circuit 33, thus the antenna 31 transmits the selected item of the specific identification data to a reader accordingly.

According to the second embodiment, by using switching circuit 39 and logic circuit 33, when a trigger signal is received, the antenna 31 dynamically transmits the selected specific identification data to a reader. Accordingly, RFID tag 30 alternatively retrieves and transmits different specific identification data to the reader in a dynamic way according to the trigger signal.

The way in which the switching circuit 39, triggered by logic circuit 33, alternatively retrieves the specific identification data stored in memory 35, can be designed to meet requirements (see related description in the first embodiment).

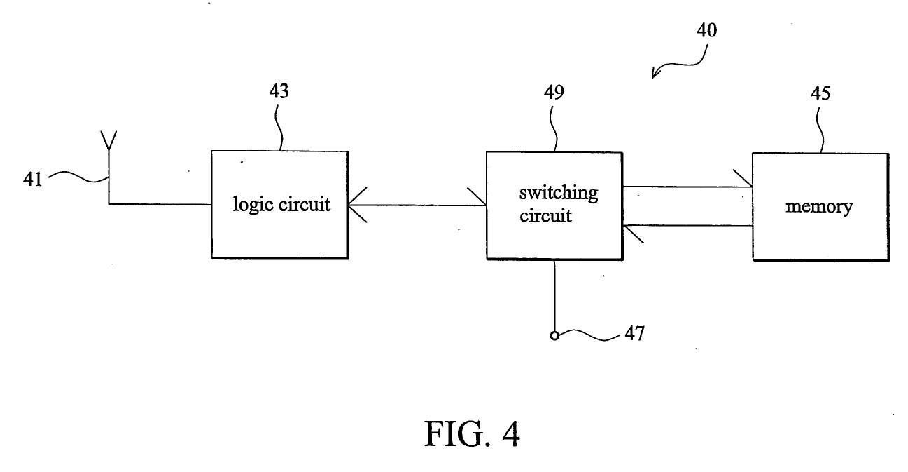

FIG. 4 illustrates a schematic view of a block diagram of a third embodiment of a radio frequency identification tag. RFID tag 40 comprises an antenna 41, a logic circuit 43, switching circuit 49, and a memory 45.

The memory 45 stores at least one item of specific identification data, comprising a signal memory unit, a plurality of memory units, or combinations thereof.

The antenna 41 establishes a wireless communication connection with a reader (not shown), and transmits/receives data between the reader and logic circuit 43. The antenna 41 transmits one item of the specific identification data stored in memory 45 according to direction of logic circuit 43.

The logic circuit 43 is connected with antenna 41, and is coupled to switching circuit 49, wherein the switching circuit 49 is coupled to memory 45. The switching circuit 49 comprises a port 47 for receiving a trigger signal from an external source, retrieves one item of the specific identification data from the memory 45 according to the trigger signal, and transmits the retrieved item to the antenna 41 through logic circuit 43, thus the antenna 41 transmits the selected item of the specific identification data to a reader accordingly.

According to the third embodiment, by using switching circuit 49 and logic circuit 43, when a trigger signal is received, the antenna 41 dynamically transmits the selected specific identification data to a reader according to direction of logic circuit 43. Accordingly, RFID tag 40 alternatively retrieves and transmits different specific identification data to the reader in a dynamic way according to the trigger signal.

The way in which the switching circuit 49 alternatively retrieves the specific identification data stored in memory 45 can be designed to meet requirements (see related description in the first embodiment).

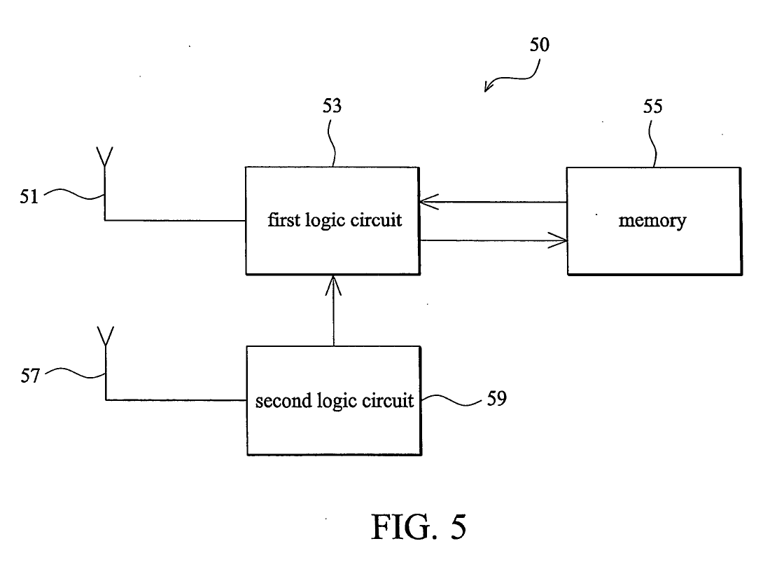

FIG. 5 illustrates a schematic view of a block diagram of a fourth embodiment of a radio frequency identification tag. RFID tag 50 comprises a first antenna 51, a first logic circuit 53, a second antenna 57, a second logic circuit 59, and a memory 55.

The memory 55 stores at least one item of specific identification data, comprising a signal memory unit, a plurality of memory units, or combinations thereof.

The first antenna 51 establishes a wireless communication connection with a reader (not shown), and transmits/receives data between the reader and first logic circuit 53. The first antenna 51 transmits one item of the specific identification data stored in memory 55 according to direction of first logic circuit 53.

The first logic circuit 53 is connected with first antenna 51, and is coupled to memory 55 and second logic circuit 59.

The second logic circuit 59 is connected with second antenna 57 operating in a frequency different from first antenna 51 for receiving a trigger signal from an external source, and relays the trigger signal to first logic circuit 53. The first logic circuit 53 selects one item of the specific identification data from the memory 55 according to the trigger signal, and directs the first antenna 51 to transmit the selected item to the antenna a reader accordingly.

According to the fourth embodiment, by using first logic circuit 53 and second logic circuit 59, when a trigger signal is received by second antenna 57, the first antenna 51 dynamically transmits the selected specific identification data to a reader according to the direction of first logic circuit 53. Accordingly, RFID tag 50 alternatively retrieves and transmits different specific identification data to the reader in a dynamic way according to the trigger signal.

The way in which the first logic circuit 53, alternatively retrieves the specific identification data stored in memory 55, can be designed to meet requirements (see related description in the first embodiment).

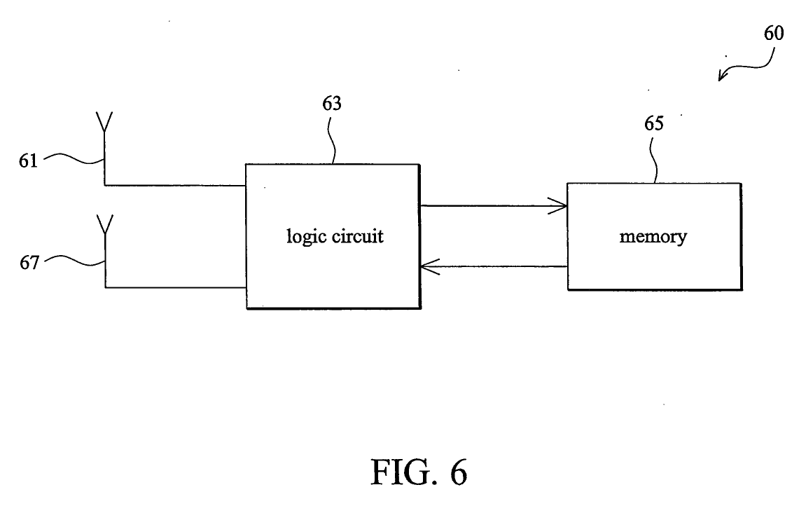

FIG. 6 illustrates a schematic view of a block diagram of a fifth embodiment of a radio frequency identification tag. RFID tag 60 comprises a first antenna 61, a logic circuit 63, a memory 65, and a second antenna 67.

The memory 65 stores at least one item of specific identification data, comprising a signal memory unit, a plurality of memory units, or combinations thereof.

The first antenna 61 establishes a wireless communication connection with a reader (not shown), and transmits/receives data between the reader and logic circuit 63. The first antenna 61 transmits one item of the specific identification data stored in memory 65 according to direction of logic circuit 63.

The logic circuit 63 is connected with first antenna 61 and second antenna 67, respectively, wherein the first antenna 61 operates in a frequency different from second antenna 67.

The logic circuit 63 receives a trigger signal from an external source through second antenna 67, and selects one item of the specific identification data from the memory 65 according to the trigger signal, and directs the first antenna 61 to transmit the selected item to the antenna a reader accordingly.

According to the fourth embodiment, by using logic circuit 63, when a trigger signal is received by second antenna 67, the first antenna 61 dynamically transmits the selected specific identification data to a reader according to the direction of logic circuit 63. Accordingly, RFID tag 60 alternatively provides different specific identification data to the reader in a dynamic way according to the trigger signal.

The way in which the logic circuit 63, alternatively retrieves the specific identification data stored in memory 65, can be designed to meet requirements (see related description in the first embodiment).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A radio frequency identification tag, comprising:
a memory, storing at least one item of specific identification data;
a logic circuit, coupled to the memory, comprising at least one port for receiving a trigger signal from an external source, and selecting and retrieving one item of the specific identification data from the memory according to the trigger signal; and
an antenna, connected to the logic circuit, transmitting the specific identification data retrieved by the logic circuit.

2. The radio frequency identification tag of claim 1, wherein the trigger signal is generated by a sensor.

3. The radio frequency identification tag of claim 1, wherein the trigger signal is generated by a switching operation.

4. The radio frequency identification tag of claim 1, wherein the memory comprises a signal memory unit divided into a plurality of memory sectors, each of which stores one item of the specific identification data.

5. The radio frequency identification tag of claim 1, wherein the memory comprises a plurality of memory units, each of which stores one item of the specific identification data.

6. The radio frequency identification tag of claim 1, wherein the memory comprises a plurality of memory units, wherein at least one of the memory units is divided into a plurality of memory sectors, and each of the memory sectors stores one item of the specific identification data and each of the other memory units stores one item of the specific identification data.

7. The radio frequency identification tag of claim 1, wherein the logic circuit alternatively selects one item of the specific identification data stored in the memory in a sequential order.

8. The radio frequency identification tag of claim 1, wherein the logic circuit alternatively selects one item of the specific identification data stored in the memory in a sequential order recurrently.

9. The radio frequency identification tag of claim 1, wherein the trigger signal comprises data designation information for designating one item of the specific identification data stored in the memory, and the logic circuit selects one item of the specific identification data stored in the memory according to the data designation information of the trigger signal.

10. A radio frequency identification tag, comprising:
a memory, storing at least one item of specific identification data;
a switching circuit, comprising at least one port for receiving a trigger signal from an external source, and selecting one item of the specific identification data stored in the memory according to the trigger signal;
a logic circuit, coupled to the memory and the switching circuit respectively, retrieving the selected item of the specific identification data from the memory; and
an antenna, connected to the logic circuit, transmitting the specific identification data retrieved by the logic circuit.

11. The radio frequency identification tag of claim 10, wherein the trigger signal is generated by a sensor.

12. The radio frequency identification tag of claim 10, wherein the trigger signal is generated by a switching operation.

13. The radio frequency identification tag of claim 10, wherein the memory comprises a signal memory unit divided into a plurality of memory sectors, each of which stores one item of the specific identification data.

14. The radio frequency identification tag of claim 10, wherein the memory comprises a plurality of memory units, each of which stores one item of the specific identification data.

15. radio frequency identification tag of claim 10, wherein the memory comprises a plurality of memory units, wherein at least one of the memory units is divided into a plurality of memory sectors, and each of the memory sectors stores one item of the specific identification data and each of the other memory units stores one item of the specific identification data.

16. The radio frequency identification tag of claim 10, wherein the switching circuit alternatively selects one item of the specific identification data stored in the memory in a sequential order.

17. The radio frequency identification tag of claim 10, wherein the switching circuit alternatively selects one item of the specific identification data stored in the memory in a sequential order recurrently.

18. The radio frequency identification tag of claim 10, wherein the trigger signal comprises data designation information for designating one item of the specific identification data stored in the memory, and the switching circuit selects one item of the specific identification data stored in the memory according to the data designation information of the trigger signal.

19. A radio frequency identification tag, comprising:
a memory, storing at least one item of specific identification data;
a switching circuit, coupled to the memory, comprising at least one port for receiving a trigger signal from an external source, and selecting and retrieving one item of the specific identification data stored in the memory according to the trigger signal;
a logic circuit, coupled to the switching circuit, receiving the retrieved item of the specific identification data from the switching circuit; and
an antenna, connected to the logic circuit, receiving the specific identification data from the logic circuit, and transmitting the received specific identification data.

20. The radio frequency identification tag of claim 19, wherein the trigger signal is generated by a sensor.

21. The radio frequency identification tag of claim 19, wherein the trigger signal is generated by a switching operation.

22. The radio frequency identification tag of claim 19, wherein the memory comprises a signal memory unit divided into a plurality of memory sectors, each of which stores one item of the specific identification data.

23. The radio frequency identification tag of claim 19, wherein the memory comprises a plurality of memory units, each of which stores one item of the specific identification data.

24. The radio frequency identification tag of claim 19, wherein the memory comprises a plurality of memory units, wherein at least one of the memory units is divided into a plurality of memory sectors, and each of the memory sectors stores one item of the specific identification data and each of the other memory units stores one item of the specific identification data.

25. The radio frequency identification tag of claim 19, wherein the switching circuit alternatively selects one item of the specific identification data stored in the memory in a sequential order.

26. The radio frequency identification tag of claim 19, wherein the switching circuit alternatively selects one item of the specific identification data stored in the memory in a sequential order recurrently.

27. The radio frequency identification tag of claim 19, wherein the trigger signal comprises data designation information for designating one item of the specific identification data stored in the memory, and the switching circuit selects one item of the specific identification data stored in the memory according to the data designation information of the trigger signal.

28. A radio frequency identification tag, comprising:
a memory, storing at least one item of specific identification data;
a second antenna, receiving a trigger signal from an external source;
a second logic circuit, receiving the trigger signal from the second antenna, and transmitting the received trigger signal to a first logic circuit;
a first logic circuit, coupled to the second logic circuit, receiving the trigger signal from the second logic circuit, selecting and retrieving one item of the specific identification data stored in the memory according to the trigger signal; and
a first antenna, coupled to the first logic circuit, operating in a frequency different from the second antenna, receiving the specific identification data from the first logic circuit, and transmitting the received specific identification data.

29. The radio frequency identification tag of claim 28, wherein the trigger signal is generated by a sensor.

30. The radio frequency identification tag of claim 28, wherein the trigger signal is generated by a switching operation.

31. The radio frequency identification tag of claim 28, wherein the memory comprises a signal memory unit divided into a plurality of memory sectors, each of which stores one item of the specific identification data.

32. The radio frequency identification tag of claim 28, wherein the memory comprises a plurality of memory units, each of which stores one item of the specific identification data.

33. The radio frequency identification tag of claim 28, wherein the memory comprises a plurality of memory units, and at least one of the memory units is divided into a plurality of memory sectors, and each of the memory sectors stores one item of the specific identification data and each of the other memory units stores one item of the specific identification data.

34. The radio frequency identification tag of claim 28, wherein the first logic circuit alternatively selects one item of the specific identification data stored in the memory in a sequential order.

35. The radio frequency identification tag of claim 28, wherein the first logic circuit alternatively selects one item of the specific identification data stored in the memory in a sequential order recurrently.

36. The radio frequency identification tag of claim 28, wherein the trigger signal comprises data designation information for designating one item of the specific identification data stored in the memory, and the first logic circuit selects one item of the specific identification data stored in the memory according to the data designation information of the trigger signal.

37. A radio frequency identification tag, comprising:
a memory, storing at least one item of specific identification data;
a first antenna, transmitting one of the specific identification data;
a second antenna, operating in a frequency different from the first antenna, receiving a trigger signal from an external source;
a logic circuit, coupled to the first antenna, second antenna, and the memory respectively, selecting and retrieving one item of the specific identification data stored in the memory according to the trigger signal, and relaying the specific identification data to the first antenna for transmission.

38. The radio frequency identification tag of claim 37, wherein the trigger signal is generated by a sensor.

39. The radio frequency identification tag of claim 37, wherein the trigger signal is generated by a switching operation.

40. The radio frequency identification tag of claim 37, wherein the memory comprises a signal memory unit divided into a plurality of memory sectors, each of which stores one item of the specific identification data.

41. The radio frequency identification tag of claim 37, wherein the memory comprises a plurality of memory units, each of which stores one item of the specific identification data.

42. radio frequency identification tag of claim 37, wherein the memory comprises a plurality of memory units, wherein at least one of the memory units is divided into a plurality of memory sectors, and each of the memory sectors stores one item of the specific identification data and each of the other memory units stores one item of the specific identification data.

43. The radio frequency identification tag of claim 37, wherein the logic circuit alternatively selects one item of the specific identification data stored in the memory in a sequential order.

44. The radio frequency identification tag of claim 37, wherein the logic circuit alternatively selects one item of the specific identification data stored in the memory in a sequential order recurrently.

45. The radio frequency identification tag of claim 37, wherein the trigger signal comprises data designation information for designating one item of the specific identification data stored in the memory, and the logic circuit selects one item of the specific identification data stored in the memory according to the data designation information of the trigger signal.
